(19) United States
(12) Patent Application Publication
(10) Pub. No.: US 2013/0201830 A1
(43) Pub. Date: Aug. 8, 2013

(54) Machine Type Communications Connectivity Sharing

(71) Applicants: Peter S. Wang, East Setauket, NY (US); Kai Liu, S. Huntington, NY (US); Pascal M. Adjakple, Great Neck, NY (US); Mahmoud Watfa, Saint Leonard (CA); Samian J. Kaur, Plymouth Meeting, PA (US); Saad Ahmad, Montreal (CA)

(72) Inventors: Peter S. Wang, East Setauket, NY (US); Kai Liu, S. Huntington, NY (US); Pascal M. Adjakple, Great Neck, NY (US); Mahmoud Watfa, Saint Leonard (CA); Samian J. Kaur, Plymouth Meeting, PA (US); Saad Ahmad, Montreal (CA)

(73) Assignee: INTERDIGITAL PATENT HOLDINGS, INC., Wilmington, DE (US)

(21) Appl. No.: 13/571,631

(22) Filed: Aug. 10, 2012

Related U.S. Application Data
(60) Provisional application No. 61/522,386, filed on Aug. 11, 2011.

(51) Int. Cl. H04W 40/24

(52) U.S. Cl. CPC H04W 40/24
USPC 370/235; 370/329; 370/315

(57) ABSTRACT

Methods, apparatuses, and systems are described for machine type communication (MTC) devices to share the same data path when the MTC devices transmit data to destination, or vice versa. The shared data path may run through the whole length of the traffic end-to-end or a segment between two nodes. A method may involve routing a first communication from a first MTC device toward a first MTC server through a logical 3GPP path between a first 3GPP network node and a second 3GPP network node. The logical 3GPP path is assigned a path identifier. The method may also comprise routing a second communication from a second MTC device toward a second MTC server through the logical 3GPP path.

### CROSS-REFERENCE TO RELATED APPLICATION

This application claims the benefit of U.S. Provisional Application 61/522,386 filed on Aug. 11, 2011, the contents of which are hereby incorporated by reference in their entirety.

### BACKGROUND

Machine-to-machine (“M2M”) communications refer to a category of communications carried out by, between and/or among devices, referred to as machines, adapted to send, receive or exchange, via such M2M communications, information for performing various applications (“M2M applications”), such as smart metering, home automation, eHealth, and fleet management. In general, execution of the various applications, and in turn, the M2M communications attendant to such execution are carried out by the machines without necessitating human intervention for triggering, initiating and/or causing origination of the M2M communications. Understandably, successful implementation and proliferation of the M2M applications is likely dependent upon industry-wide acceptance of standards that ensure (e.g., define requirements for ensuring) inter-operability among the various machines, which may be manufactured and operated by various entities.

### SUMMARY

In one embodiment, a method for managing machine type communications comprises routing a first communication from a first machine type communication (MTC) device toward a first MTC server through a logical 3GPP path between a first 3GPP network node and a second 3GPP network node. The logical 3GPP path is assigned a path identifier. The method may also comprise routing a second communication from a second MTC device toward a second MTC server through the logical 3GPP path. The method may be embodied in an apparatus or a tangible computer readable storage medium.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIGS. 1C, 1D, and 1E are system diagrams of example radio access networks and example core networks that may be used within the communications system illustrated in FIG. 1A;

FIG. 2 is a system diagram showing various MTC traffic paths in accordance with one non-limiting embodiment;

FIG. 3 is a block diagram illustrating shared network segments in accordance with one non-limiting embodiment;

FIGS. 4-6 illustrate message structures in accordance with various non-limiting embodiments; and

FIG. 7 is a network diagram that illustrates a 3GPP network having a variety of 3GPP core network nodes and logical connectivity entities that can be established between them.

### DETAILED DESCRIPTION

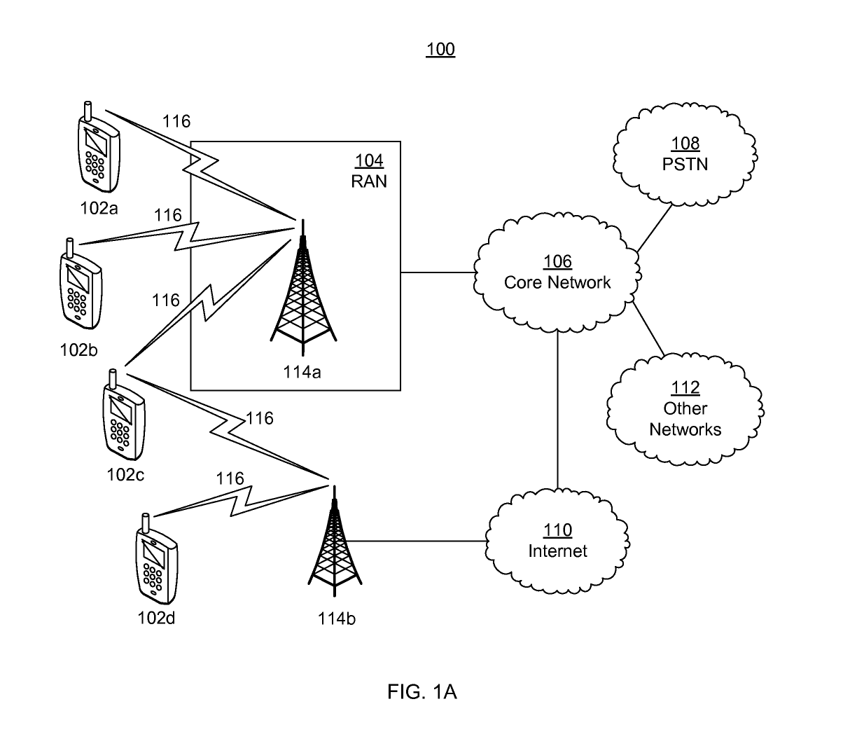

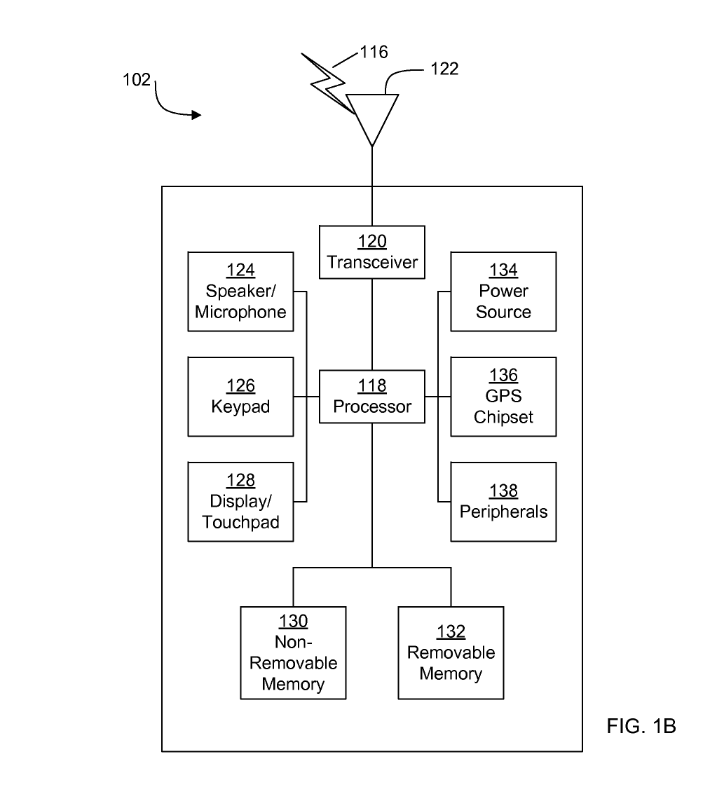

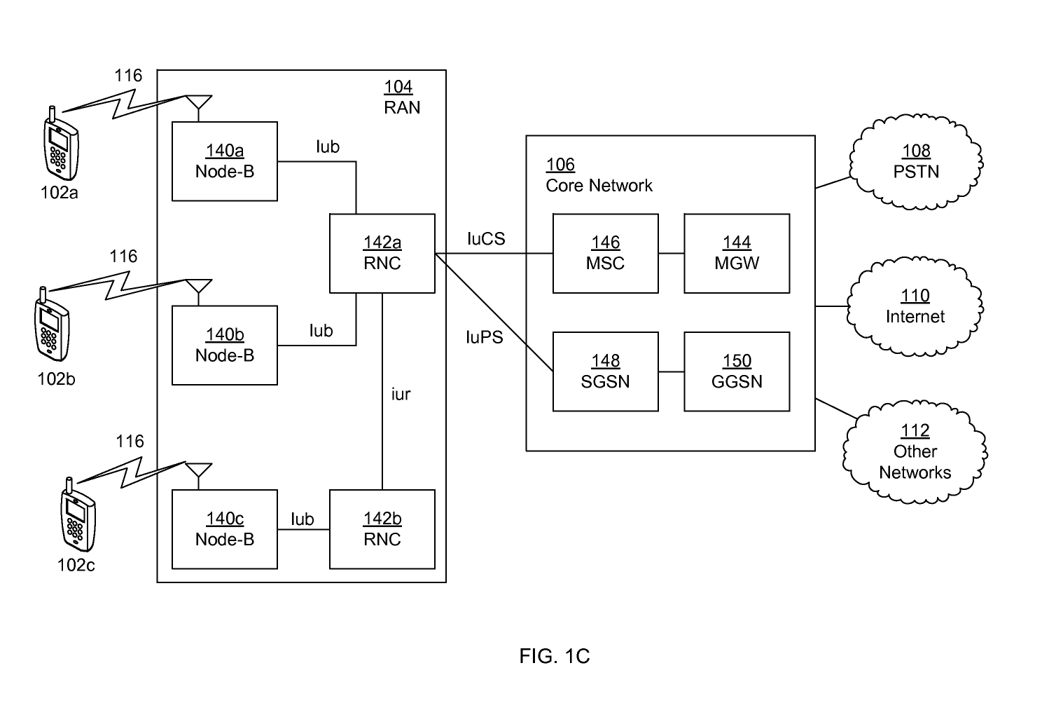

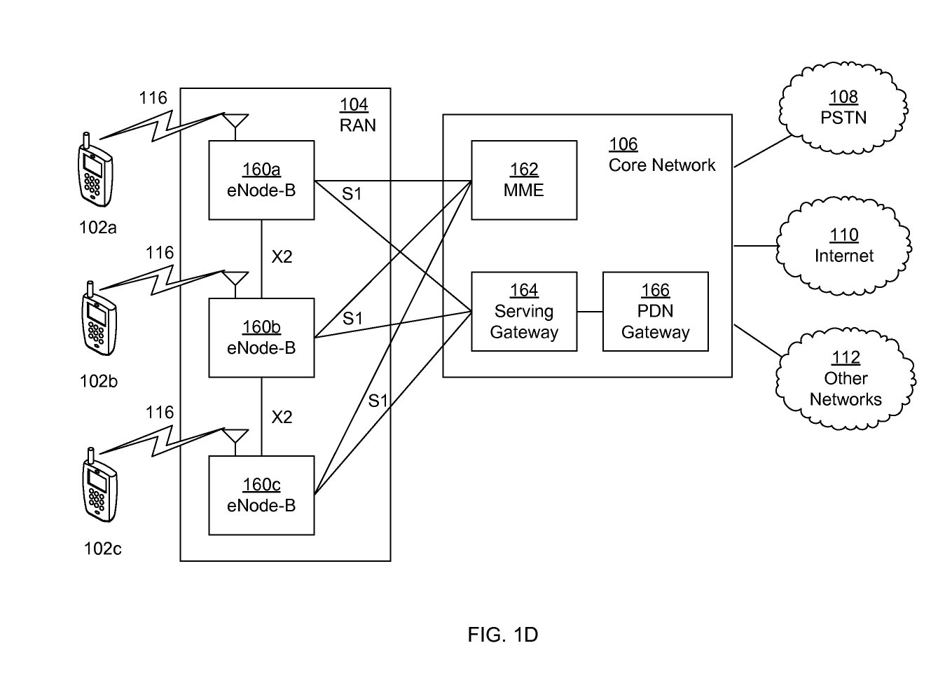

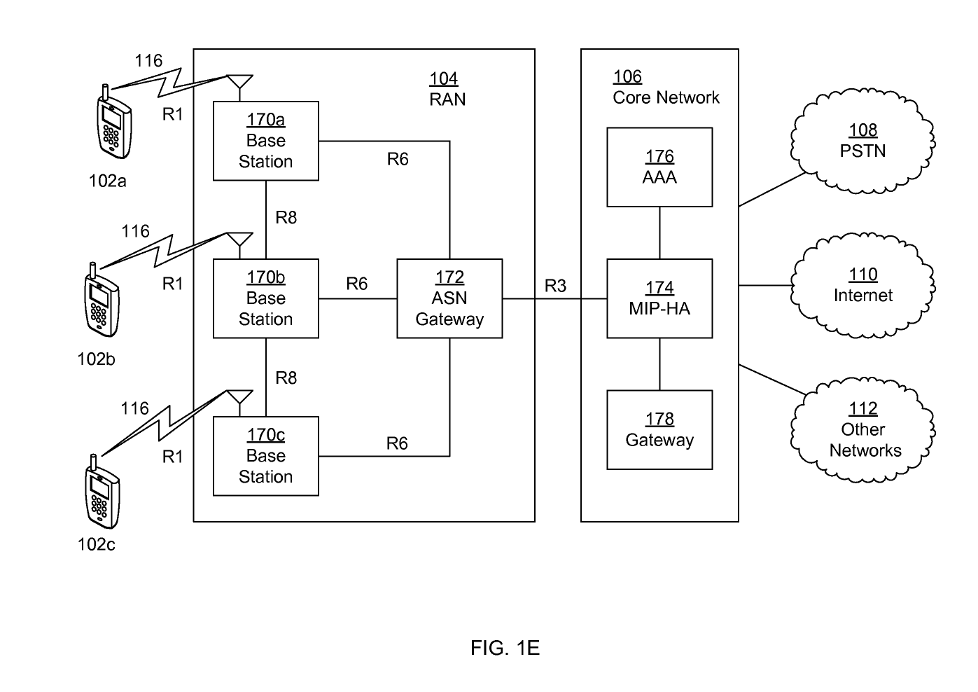

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to another embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 106 shown in FIG. 1D may include a mobility management entity (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to another embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 170a, 170b, 170c, and an ASN gateway 172, though it will be appreciated that the RAN 104 may include any number of base stations and ASN gateways while remaining consistent with an embodiment. The base stations 170a, 170b, 170c may each be associated with a particular cell (not shown) in the RAN 104 and may each include one or more transceivers for communicating with the WTRUs 102a, 102b, 102c over the air interface 116. In one embodiment, the base stations 170a, 170b, 170c may implement MIMO technology. Thus, the base station 170a, for example, may use multiple antennas to transmit wireless signals to, and receive wireless signals from, the WTRU 102a. The base stations 170a, 170b, 170c may also provide mobility management functions, such as handoff triggering, tunnel establishment, radio resource management, traffic classification, quality of service (QoS) policy enforcement, and the like. The ASN gateway 172 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 170a, 170b, 170c may be defined as an R8 reference point that includes protocols for facilitating WTRU handovers and the transfer of data between base stations. The communication link between the base stations 170a, 170b, 170c and the ASN gateway 172 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 174, an authentication, authorization, accounting (AAA) server 176, and a gateway 178. While each of the foregoing elements are depicted as part of the core network 106, it will be appreciated that any one of these elements may be owned and/or operated by an entity other than the core network operator. The MIP-HA 174 may be responsible for IP address management, and may enable the WTRUs 102a, 102b, 102c to roam between different ASNs and/or different core networks. The MIP-HA 174 may provide the WTRUs 102a, 102b, 102c with access to packet-switched networks, such as the Internet 110, to facilitate communications between the WTRUs 102a, 102b, 102c and IP-enabled devices. The AAA server 176 may be responsible for user authentication and for supporting user services. The gateway 178 may facilitate interworking with other networks. For example, the gateway 178 may provide the WTRUs 102a, 102b, 102c with access to circuit-switched networks, such as the PSTN 108, to facilitate communications between the WTRUs 102a, 102b, 102c and traditional land-line communications devices. In addition, the gateway 178 may provide the WTRUs 102a, 102b, 102c with access to the networks 112, which may include other wired or wireless networks that are owned and/or operated by other service providers. Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Machine-to-Machine (M2M) communication, or machine-type communications (MTC) as sometimes referred to by 3GPP, is generally a form of data communication between entities that do not necessarily need human interaction. MTC devices and smart services offerings may be provided across a wide variety of market segments and applications, including, but not limited to, healthcare, manufacturing, utilities, retail, distribution and consumer products. MTC devices may allow for smart grid technology enabling utilities to wirelessly connect to grid assets, such as circuit breakers, transformers and other sub-station equipment.

With MTC devices, and the associated M2M communications, being such a rapidly expanding sector, increasing consumption of network resources is an ongoing concern. 3GPP is in the process of establishing requirements for 3GPP network system improvements that support Machine-Type Communications (MTC). Transport services for MTC as provided by the 3GPP system and the related optimizations are being considered as well as aspects needed to ensure that MTC devices, MTC servers, and/or MTC applications do not cause network congestion or system overload. It is also important to enable network operators to offer MTC services at a low cost level, to match the expectations of mass-market machine-type services and applications.

One goal sought for MTC devices is to efficiently maintain connectivity for a large number of MTC devices. MTC devices may be categorized for “high availability” applications. The category of “high availability” MTC devices may include applications in which the network connection must be available most of the time, since transmission of data is usually linked to emergency events. For example, MTC devices requiring efficiently maintained connectivity may be deployed for public safety and/or for security-related applications, such as security monitoring, fire alarm equipment, flood detection equipment, etc. For such MTC devices, both the uplink and the downlink communications may require high connectivity in the network system. Thus, system communication setup may not be delay-tolerant. From this perspective, such MTC devices may be considered with “higher priority” than normal MTC devices for access to the network and for the use of network resources.

In General Packet Radio Service (GPRS)/Evolved Packet System (EPS), after the UE accesses the network and obtains an IP address, it can be regarded as an “always on” UE from the perspective of the application layer. For such UEs, the goal of efficiently maintaining connectivity for a large number of MTC devices may include accessing some UEs accessed as soon as possible. For such MTC devices, it may be desired to efficiently maintain the connectivity in the network. In other words, such MTC devices may be expected to be treated as “always-on” and as “accessed ASAP” devices in the network.

Functionality that promotes efficiently maintaining connectivity for a large number of MTC devices may include the ability for the MTC device to set up the connection to the MTC Server as soon as possible, the ability for the MTC Server to set up the connection to the MTC device as soon as possible, the ability to reduce resource consumption in the network for maintaining connectivity for a large number of MTC devices, and the ability to optimize the mobility management and session management procedures. Further, the network may have mechanisms to reduce the signaling resources used to maintain the connectivity and mechanisms that can respond to the connectivity events (e.g., connectivity setup, tear down and loss, etc.) effectively and quickly. The network nodes (e.g., MME/SGSN, S-GW, P-GW) may have mechanisms to reduce the computational resources (e.g., CPU cycles, memory for contexts, etc.) usage for the connectivity of the UE configured for MTC.

For “always on” UEs, the network needs to maintain the UE context in the network. For a large number of MTC devices in an “always on” state, the network may need to maintain a large number of such contexts, which could lead to extensive network resource consumption. In some embodiments, the systems and methods described herein may address the goal of efficiently maintaining connectivity for a large number of MTC devices while also considering network resource consumption.

Considering that both the mobile originated (MO) and mobile terminated (MT) communications should be established as soon as possible, the network should be able to assign network resources to such MTC devices with higher priority compared to the normal MTC devices, even during congestion or overload conditions. Connections should be available or should be able to be established quickly most of the time for such MTC devices.

For supporting MTC devices for which it is desirable to efficiently maintain connectivity, the detailed network capabilities and functionalities described herein address the connectivity sharing and maintenance efficiency as well as the objectives of reducing network resource consumption and facilitating the possible MTC device mobility management and session management. Mechanisms for MTC connectivity entity creation, sharing, and maintenance in both core network and LTE radio access network resources are also described herein.

Furthermore, mechanisms for MTC devices to receive the network connectivity sharing configurations and methods for dividing the different MTC devices into different sharable connectivity entities are described herein. MTC device sharable data formats and related routing methods are also described herein.

As used in this disclosure, the term “traffic” may broadly refer to application data traffic, application signaling traffic, or signaling generated and exchanged between the WTRU and the network below the application layer or signaling traffic generated and exchanged between network nodes. Moreover, an eNode B may also refer to a Node B, an RNC, a Home eNode B, Home NodeB, or a Home Node B Gateway. Similarly, an MME may also refer to a Serving GPRS Support Node (SGSN), or an MSC/VLR. Thus, the systems and methods described herein are not limited to any particular type of access network, but instead may be applied across a wide array of access network technologies. The access network may be, for example, a network configured for communication in accordance with one or more protocols for (i) digital subscriber line technologies (collectively referred to as “xDSL”), (ii) hybrid-fiber-coax (HFC) networks, (iii) programmable logic controllers (PLC), (iv) satellite communications and networks, (v) Global System for Mobile telecommunication (GSM)/Enhanced Data GSM Environment (EDGE) radio access networks (GERANs), (vi) Universal Mobile Telecommunication System (UMTS) Terrestrial Radio Access Networks (UTRANs), (vii) evolved UTRANs (eUTRANs), (viii) wireless local area networks (WLANs), Worldwide Interoperability for Microwave Access (WiMAX), and the like.

The systems and methods described herein provide MTC data path sharing or connectivity sharing. In accordance with various embodiments, multiple MTC devices share a same logical and/or physical data path and the network node/entity that the path runs through in the network when the MTC devices transmit data from the device to the ultimate MTC server or destination, or vice versa. The data path or the connectivity may run through the whole length of the traffic end-to-end or a segment between two nodes, as described in more detail below. Generally, the MTC data connectivity sharing described herein may reduce the network resources consumed by a large number of MTC devices, and it may also reduce signaling overhead and network management overhead.

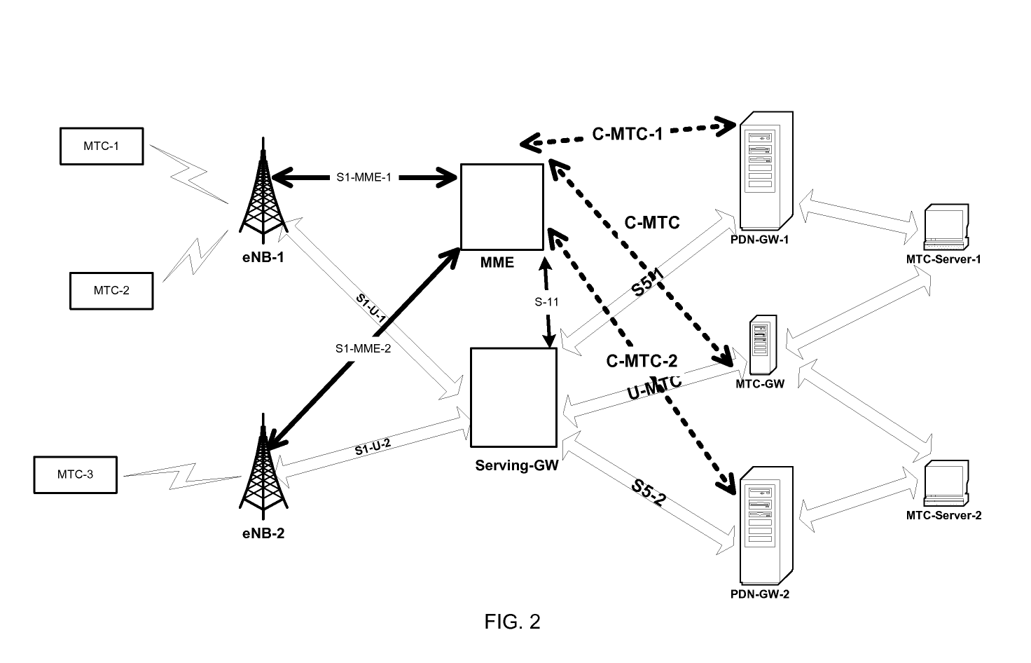

FIG. 2 is a system diagram showing various MTC traffic paths in accordance with one non-limiting embodiment. As illustrated in FIG. 2, a variety of possible routes (e.g., network or connectivity segments) between nodes in a network 200 may be shared. Out from an eNodeB 202, 204, the sharable routes may be include a route to a MME 206, a route to a serving gateway (S-GW) 208, and a route to a local GW (LGW) 210 if local IP access or IP offload is used or if a LGW is deployed, which may be allowed for use by these devices. Out from the S-GW 208, the sharable routes may include a route to a particular P-GW 212, 214 or LGW (APN) 210 through which a particular MTC-server 216, 218 is connected, a route to a general P-GW 212, 214 or LGW 210 if all MTC-servers are connected to this core network (CN) via that one P-GW 212, 214, to a P-GW 212, 214 or LGW 210 that is the IP Point of Presence for that MTC device, and to a possible MTC specific node in the CN that handles all MTC-related traffic between the CN and MTC-servers, such as a MTC-GW or a MTC-IWF or a MTC-SMS, etc. As is to be appreciated, the MTC specific node may be connected to an eNodeB, MME, SGW, or PDN GW, or any combination of such nodes. Out from the MME 206, the sharable routes may include the route to the S-GW 208 and then subsequently connecting to a P-GW 212, 214 or to a MTC specific node such as a MTC-GW as described above, and to a possible MTC specific node in the CN that handles all MTC related traffic between the CN and MTC-servers, such as a MTC-GW or a MTC-IWF or a MTC-SMS as described above, etc.

Even though the sharable routes in FIG. 2 are described in the context of LTE/E-UTRAN, the present disclosure is not so limited. Similar systems and methods may apply to other access networks, such as UTRAN or GREAN where an eNodeB is represented by a nodeB (NodeB). In addition, an RNC may exist between the NodeB and the CN nodes. Thus, for UTRAN/GERAN, the same connectivity path as those listed above will also apply. Moreover, the RNC/HNodeB/HNodeB GW may be in between the path or it may also terminate a path. The shared path may also be utilized in CS-domain resources and the same proposals herein apply with merely minor changes, e.g., MSC/VLR may replace SGSN/MME, etc.

Furthermore, one or more MTC devices illustrated in FIG. 2 may be an MTC device aggregation node or an MTC device concentration node (i.e., a network of MTC devices). Thus, each individual MTC device may or may not be directly visible to the RAN or core network. For example, the MTC aggregation node could be visible to the RAN or the core network node, while the individual MTC devices are visible to the MTC server. Moreover, the connection between the individual MTC devices and the MTC device aggregation node may or may not use the same access technology as the connection between the MTC device aggregation node and the cellular network. For example, connections between individual MTC devices and the MTC device aggregation node could use a Bluetooth technology, while the MTC aggregation connection to the remote MTC server may use a cellular network connection. The MTC device aggregation node could take the form of a UE, a regular eNodeB, a relay, a Home eNodeB, or the like.

In some embodiments, a MTC device may or may not initially be aware of the pathway sharing or be permitted to share. In some embodiments, sharing may only occur after a device explicitly indicates that sharing is allowed for its application or traffic, which may be for a given period of time or conditioned on other metrics.

Generally, the MTC data path sharing may start from a base station, such as, without limitation, an eNodeB, a NodeB, or RNC/HNodeB/HNodeB GW. From there, multiple segments of the connectivity path between any two nodes along the way to the ultimate destination, e.g., an MTC-server, may be used for traffic. Each segment may have one or more instances for different sharing properties. With specific reference to a 3G UTRAN access network, the connectivity path could include a segment between a NodeB and an RNC.

As a system activity, the MTC connectivity sharing may be enabled (e.g., activated) when the network nodes are powered up and initialized. In some embodiments, MTC connectivity sharing (or sharing path) for one or more segments may be enabled or started only after any combination of one or more of the following conditions is met:

(1) There are N devices that are available or willing to share a connection, where N is an integer that may be predefined (e.g., configured by the operator);

(2) The connectivity may only be shared within a known/preconfigured time;

(3) The connectivity may only be shared by a group of devices that are operating in a specific mode (e.g., delay-tolerant, time-controlled, devices that perform MO-traffic, etc.), or a combination of modes;

(4) The connectivity sharing may occur as a result of an explicit indication from the UE or from a CN node, e.g., MME or Home Subscriber Server (HSS); and/or

(5) The connectivity sharing may be started when specific types of applications are needed or when the traffic requires a specific QoS, or when the traffic is of a particular form (e.g., SMS, etc.).

In other embodiments, other conditions may be defined. By way of example and not limitation, a condition may be defined that connectivity sharing can only occur over the packet switched (PS) domain or over the circuit switched (CS) domain. As another example, a condition may be defined that connectivity sharing can only occur when the traffic is CS-based or PS-based.

In some embodiments, MTC connectivity sharing may be terminated after any combination of one or more of the following conditions is met:

(1) The number of sharing devices falls below N, with N being an integer that may be defined, for example, by the operator;

(2) When the sharing interval ends;

(3) When the devices' mode of operation changes from any mode to another (in some embodiments, the actual change in mode that triggers termination of MTC connectivity sharing may be defined by the network operator);

(4) An explicit indication is received by the UE (e.g., from the network) or by the network (e.g., from the UE or HSS or MTC server or MTC peer); and/or

(5) When a specific QoS is required such that the resources cannot be shared.

Note that for starting and/or terminating connectivity sharing, if an explicit indication is needed by any node, the indication may be in the form of NAS, RRC or other control messages (e.g., OMA DM, OTA, SMS, etc.) over various network interfaces.

The network and/or UE may choose a specific path to be shared based on a variety of factors. By way of example and not limitation, the network load on a specific path or set of path may be considered. If a specific path is congested and there are multiple devices that would require connection on that path, then the network may decide to have these devices share a connection/resource so that the network load does not increase on that path due to resource reservation per device. Another factor considered by the network and/or UE may be the device subscription information. The device subscription information may define which path, end-to-end or a specific segment, should be shared and for what type of traffic, time, or any of the above criteria, as well as other criteria. In some embodiments, the subscription information may also define whether a UE is allowed to use explicit resources that are not shared with devices.

As used herein, the MTC sharable data traffic includes the designated MTC traffic (e.g., all MTC traffic or a defined set of MTC traffic) from or to one MTC device that could be transmitted in a logical and/or physical pathway together with another sharable data traffic from/to another MTC device. Generally, MTC connectivity sharing may utilize the following principles. Given an MTC traffic path from the starting point to the terminating point has more than one network node (N, including the ultimate MTC-Server but excluding the MTC-device itself) on the path, the whole path through the network comprises (N-1) segments. For example, referring to FIG. 2, one possible path between MTC-1 and MTC-Server-1 consists of 4 nodes (the eNodeB-1, the MME, the MTC-GW, and the MTC-Server-1) and 3 segments (the S1-MME-1, the C-MTC, and the segment between the MTC-GW and the MTC-server-1). Under connectivity sharing, each network node may have one or more MTC connectivity sharing paths going in from different nodes, or it may have one or more MTC connectivity sharing paths going out to different nodes. A connectivity sharing path between two nodes may be shared by MTC sharable traffic originated from different MTC devices but travel over a path comprises two of the same nodes.

In some embodiments, the MTC sharing connectivity built or established over network segments is a logical entity. Using a logical entity may promote efficiently maintaining connectivity with the least amount of resource and the least amount of signaling overhead. The logical connectivity entity could be built directly on top of the physical connections, for example, on top of the data link layer of the asynchronous transfer mode (ATM) layer. Alternatively, the logical connectivity entity could be built based on the GTP-U. As another alternative, the logical entity could be built similarly as the 3GPP EPS bearers, such as the S1 or S5.

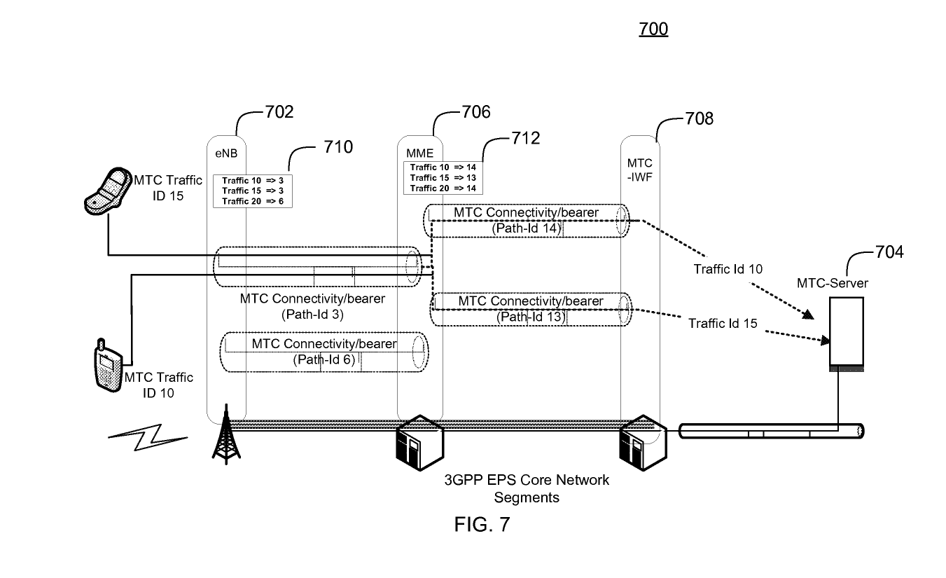

One or more of the logical connectivity entities could be established between two core network end points. FIG. 7 is a network diagram that illustrates a 3GPP network 700 having a variety of 3GPP core network nodes and logical connectivity entities that can be established between them. The logical connectivity entities could be in any two points of the 3GPP core network nodes, e.g., between an eNB 702 and a S-GW 704, between a MME 706 and the S-GW 704 or a P-GW or between the MME 706 and the P-GW or between a MTC-IWF 708 and the S-GW 704 or P-GW, etc. Theoretically the sharing connectivity in the network is configured in a Machine to Machine situation in the 3GPP core networks that handle the MTC traffic.

In some embodiments, one or more MTC connectivity sharing paths may exist in each of the network segments. For example, a segment may have one MTC connectivity sharing path defined to accommodate all kinds of MTC sharable data traffic. Alternatively, a plurality of connectivity sharing paths may be defined for a segment, with each of the plurality of connectivity sharing paths accommodating a specific kind of MTC sharable data traffic.

In some embodiments, a first MTC sharable data traffic (e.g., from a particular MTC device starting at a particular eNodeB to a particular MTC-server) in one network segment may share with a second MTC sharable data traffic. In yet another or next network segment, however, the first MTC sharable data traffic may share with a third MTC sharable data traffic, depending on the origination and destination of the traffic route. Hence, a specific network segment (e.g., a MTC connectivity sharing path) may be shared by devices that originated from a different radio access technology. For example, MTC devices connected via WLAN may share CN resources at the SGW/PDN GW. Thus, sharing EPS resources does necessarily not limit the radio access of these devices to 3GPP access.

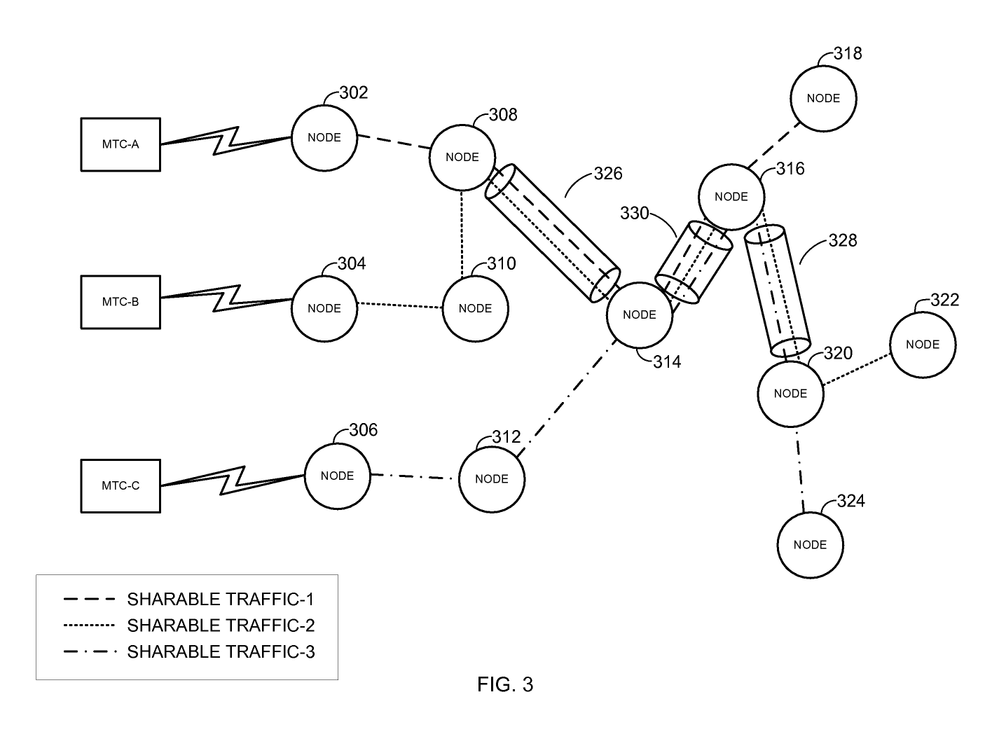

FIG. 3 is a block diagram illustrating shared network segments in accordance with one non-limiting embodiment. As illustrated, sharable traffic-1 is routed from MTC-A through nodes 302, 308, 314, 316, and 318. Sharable traffic-2 is routed from MTC-B through nodes 304, 310, 308, 314, 316, 320, 320, and 322. Sharable traffic-3 is routed from MTC-C through nodes 305, 312, 314, 316, 320, 324. Sharable traffic-1 and sharable traffic-2 share the segments between nodes 308, 314, and 316. As illustrated, sharable traffic-1 and sharable traffic-2 share MTC connectivity sharing path 326 in between nodes 308 and 314. Since sharable traffic-1, sharable traffic-2, and sharable traffic-3 all share the same path between node 314 and node 316, all of the traffic shares MTC connectivity sharing path 330. As illustrated, sharable traffic-2 and sharable traffic-3 share MTC connectivity sharing path 328.

In some embodiments, on a network segment between two nodes, the MTC connectivity sharing path for the MTC sharing traffic (both uplink/downlink) may be established as a fixed sharing path for MTC traffic or a semi-dynamic path for MTC traffic. For example, as a fixed sharing path for MTC traffic, the segment may be considered “always on.” A path may be “semi-dynamic” for certain MTC traffic sharing, such as between predetermined times, otherwise configured to be event-based, or other activation and deactivation times or events, as otherwise “need based.” For “semi-dynamic” paths, the shared connectivity path configuration/activation may be triggered by a variety of events or conditions, including one or more of the following: by a predetermined or pre-configured time; by a first one or N MTC sharable traffic defined and/or assigned to use the particular kind of sharing path; by a defined event (e.g., a certain amount of sharable traffic load or certain traffic routing decisions or network node up/down situations); by an explicit command from the network controlling node (e.g., a MME, a S-GW or a P-GW) on behalf of a MTC-server or a MTC-GW/MTC-IWF or equivalent or a specific MTC traffic administration and management entity; and/or by operation and maintenance (OAM) configuration.

In some embodiments, the release or sharing path deactivation may be triggered. Some conditions which may trigger the release or deactivation may include, without limitation, the following: by a predetermined or pre-configured time; by expiration of an inactivity timer (which may be set for a predetermined or pre-configured time), with the inactivity timer started or reset with each passing MTC sharable traffic in the path; by a defined event (e.g., a certain amount of sharable traffic load or a certain traffic routing decisions or network node up/down situations); and/or by a network controlling node or the node on behalf of a MTC-server or a specific MTC traffic administration and management entity with a specific command.

In accordance with various embodiments, both fixed and semi-dynamic paths may be reconfigured by reconfiguring with one or more of the following: reconfiguration of the QoS or of various levels of network resources of the path and/or allowing more or less MTC sharable traffic to the path. Alternatively or additionally, the MTC sharable traffic may be of a service or of a category or of a MTC user/subscriber, etc. In some embodiments, a counting procedure may keep track of the number of MTC devices that are eligible for path sharing. If the number of devices exceeds a certain threshold, a path may be reconfigured from a dedicated path to a shared path.

The MTC data path from a UE to the destination, e.g., the MTC-server, may need to be mapped to the sharing path defined between the individual pairs of the physical network nodes along the way. A common MTC connectivity sharing path may be defined in a network segment to accommodate all MTC sharable data traffics. Alternatively, in some embodiments, multiple MTC connectivity sharing paths may be defined in a network segment to accommodate certain designated MTC sharable data traffics. The multiple sharing paths in the segment may be formed based on the traffic, device, and/or connectivity path characteristics, as described in more detail below. Thus, shared path mapping may be needed between a MTC sharable data traffic and a particular MTC connectivity sharing path.

In some embodiments, a MTC sharable data traffic may be explicitly assigned a sharing-traffic-indicator (e.g., an alpha-numerical code) by the network or may implicitly inherit a predetermined sharing-traffic-indicator based on the MTC device category or based on the MTC data traffic category/priority/QoS (e.g., from USIM parameters). An MTC connectivity sharing path may also be configured/reconfigured or predetermined with a sharing-path-indicator. By predetermination or runtime configuration or reconfiguration, one or more of the sharing-traffic-indicators may be assigned to a sharing-path-indicator as the sharing-mapping-rules, whole path or per segment. In some embodiments, one sharing-traffic-indicator could be assigned to a plurality of sharing-path-indicators such that the mapping entity in a network node may have the flexibility of mapping to different sharing path based on its own traffic, QoS or other network or MTC operator rules, for example. A mapping action between the MTC sharable data traffic of a sharing-traffic-indicator and the MTC connectivity sharing path of a sharing-path-indicator may need to be performed according to the sharing-mapping-rules at each network node along the whole MTC traffic path MTC connectivity sharing. By using sharing-traffic-indicators and sharing-path-indicators, the sharing-mapping-rules may be reconfigured dynamically allowing the network to flexibly adjust the traffic path sharing.

In some embodiments, the network nodes may store mapping tables that can be dynamically or semi-statically configured to contain information regarding which traffic is assigned to which logical connectivity entity or bearer. For example, in FIG. 7, the eNB 702 may store a mapping table 710 that maps sharing-traffic-indicators 10, 15, and 20 to sharing-path-identifiers 3, 3, and 6, respectively. Similarly, the MME 706 may store a mapping table 712 that maps sharing-traffic-indicators 10, 15, and 20 to sharing-path-identifiers 14, 13, and 14, respectively. Accordingly, while sharing-traffic-identifiers are unique to each traffic, different traffics can have the same sharing-path-identifier, indicate that they are sharing the logical connectivity entity or bearer with which the sharing-path-identifier is associated.

In some situations, a MTC device and/or a MTC sharable data traffic may have multiple sharing-traffic-indicators that are assigned or otherwise inherited. The mapping action may take the one sharing-traffic-indicator associated with the highest-priority or highest class traffic for mapping to a corresponding shared connectivity path. If a mapping could not be found, the sharing-traffic-indicator associated with the next higher priority could be used for the mapping action.

In some embodiments, the network may adjust the sharing-traffic-indicator to sharing-path-indicator mapping rules from time to time in order to be adaptive to the network traffic load and the MTC traffic volume and other network maintenance works. For example, at time T1, a particular MTC sharable data traffic context (i.e., a sharing-traffic-indicator N1), may map to a specific sharing path with sharing-path-indicator M1. At time T2, the MTC traffic is reduced, and the node may deactivate the sharing path with sharing-path-indicator M1 while leaving the sharing context M0 intact. Thus, N1 could then be mapped to M0. Later, at time T3, the node may reactivate the sharing path with sharing-path-indicator M1, and N1 may again be mapped to the sharing path with sharing-path-indicator M1 again.

In some embodiments, the sharing path mapping rules may vary among different nodes. For example, each node may make mapping decisions by the load, by meeting the overall QoS requirements, or by the network policy or the MTC-OAM rules.

The MTC connectivity sharing path may have buffering capacity. The overall MTC traffic may then be regulated to use the allocated sharing resource sequentially and smoothly to fulfill the bandwidth allocation and QoS requirement.

In embodiments having only one MTC connectivity sharing path configured between two network nodes, the sharing-traffic-indicator value for each sharable MTC data traffic may be used as the base for prioritized scheduling. In some embodiments, a token-bucket algorithm or other control mechanism may be used for data trafficking fairness.

With the above described segment-based MTC connectivity sharing scheme in which the path exists on every segment of the MTC data traffic path, from the devices to the MTC-server, and the traffic-to-path mapping rules are set, the MTC sharable data traffic may be transmitted without needing the lengthy and overhead-laden U-plane path establishment and maintenance. Thus, the network signaling and connectivity maintenance cost may be reduced. Similarly, at the time of the individual session establishment or data transfer session initiation, there may not be a need for a C-plane path establishment effort, at least within the RAN and the core network, including the path to the MTC servers.

The MTC devices sharing the same path may be authenticated by the network before they can access to the network. In some embodiments, the network assigns the same set of security keys per shared path to the MTC devices.

The segment based MTC connectivity sharing scheme also allows for flexible connectivity sharing to accommodate MTC device mobility. For example, the MTC device sharable data traffic may be mapped to the connectivity sharing path from a new base-station (nodeB or eNodeB), base-station controller (RNC), and/or a MME/SGSN or a S-GW.

Considering the data path QoS and/or other concerns, the MTC data connectivity sharing may be enabled among MTC devices with one or more common properties. One example property may be the capability of supporting MTC data connectivity sharing. This capability may exist for all MTC devices, or may be a special capability for some of the MTC devices. Another example property may the same MTC user/subscriber, or for a specific MTC service, or a MTC service/usage category or a specific MTC user group. Yet another example property may be that the MTC devices belong to certain CSGs or specific Local Home Networks (LHNs). Still another example property may be that the data transmission or reception is for a specific assigned traffic/routing priority or sharing/routing category, which could be based on the subscription or on the nature of the traffic urgency or on the MTC data volume. One example property may be that the data transmission or reception has a specific assigned QoS (or QCI value or GBR value or AMBR value). Another example property may be that the MTC devices have the same or common network attachment point (e.g., a same eNodeB or a same NodeB or a same Home eNodeB) or the same signaling end point in the network. Still another example property may be based on UE-ID properties of the MTC devices, the IMSI properties, the HPLMN number or their group-ID properties, or other assigned sharing identity properties. Yet another example property may be that the MTC devices share the same MTC concentration node or MTC aggregation node. One example property may be that the MTC devices share the same multicast IP address.

In some embodiments, all of the MTC devices' traffic might be mapped to a single common path/bearer or to a few common paths/bearers, regardless of common properties considerations. For example, load conditions over the available sharable path might dictate the path to which a given MTC traffic is mapped.

The specific sharing capability and sharing assignment context may vary from one MTC device to another. In some embodiments, USIM parameters may be used by MTC service providers or network providers to define such sharing capability or context to a MTC device. The network may also indicate its sharing capabilities, for example, for specific segments, via RRC and/or NAS messages. The UE may use this information as well, for example, for request sharing.

The MTC Data Connectivity sharing may start from a base-station, such as an eNodeB or a NodeB, which is the converging or diverging point for MTC traffic after or before the radio interface. From an eNodeB that supports the MTC connectivity sharing towards a next network node, e.g., an MME or an S-GW, there could be one or more fixed sharing paths that are set up and never intentionally torn down unless the node powers down and/or one or more dynamic sharing paths, or both. There may be more than one next-network-node for an eNodeB/NodeB.

For the fixed sharing connectivity, the connectivity path may be established when the eNodeB/NodeB powers up or resets. If the sharing path is between the eNodeB/NodeB and a MME/RNC (or SGSN), the eNodeB/NodeB and MME/RNC (or SGSN) may start setting up such a sharing path when the eNodeB powers up or the eNodeB resets in the procedures of “S1 Setup” or “ENodeB Configuration Update” or “ENodeB Configuration Transfer” or “MME Configuration Transfer” or the like. The eNodeB may have more than one MME as a target for a MTC sharing path with them, at least one towards each. Alternatively, the sharing path may also be established upon the transmission of the first traffic packet or upon the first session management procedure, or upon the CN nodes (MME/SGSN/MSC_VLR) receiving the first UE message, such as a Service Request message, from the RAN. If the sharing path is between the eNodeB and an S-GW, the MME may be requested, in one of the above procedures, to locate the S-GW for the eNodeB and it may then respond to the eNodeB to let the eNodeB contact the S-GW for establishing such a sharing path, or it may send a command to the S-GW instructing the S-GW to establish the sharing path with the eNodeB. The eNodeB may have more than one S-GW as a target for the MTC sharing path.

In accordance with various embodiments, the eNodeB may multiplex the received packets into or out from the sharing path. The multiplex function may be implemented in a Packet Data Convergence Protocol (PDCP) layer or a layer above the PDCP layer. To support multiplexing/de-multiplexing, the eNodeB/NodeB/RNC may set up a table to store the UE with its corresponding IP address or an addressable WTRU or destination MTC-Server identification in operation. For each received packet, an eNodeB/NodeB/RNC may need to examine the IP header or the WTRU-Id to determine the target UE for which the packet is intended.

If the sharing path is between the eNodeB/RNC and the P-GW/GGSN, the MME may be requested to locate the P-GW from the eNodeB for the first session initiation, and it may then respond with the same P-GW for all subsequent sessions of the same connectivity sharing context. The S1 and the S5 bearers may be shared between the eNodeB and the P-GW.

In some embodiments, the eNodeB may multiplex the received packets into or out of the shared S1 GW. The multiplexing may be performed by an eNodeB using any suitable technique, such as, for example, using Deep Packet Inspection, maintaining a specific lookup table, or performing a Network Address Translation function. The P-GW may support multiplexing or demultiplexing, for example, by performing Deep Packet Inspection, inspecting lookup tables, performing network address translation function, or using other suitable techniques.

If the sharing path is between the S-GW and an P-GW, the MME may be requested to locate the P-GW for the eNodeB, and it may then respond to the S-GW to let the S-GW contact the P-GW for establishing such a sharing path. In some embodiments, the MME may send a command to the P-GW instructing the P-GW to establish the sharing path with the S-GW. The S-GW may multiplex the received packets into or out from the shared path. In some embodiments, the S-GW may implement the multiplexing function at the GTP layer or a layer above the GTP layer. To support multiplexing or de-multiplexing, the S-GW may set up a table to save the UE with the corresponding IP address or an addressable WTRU or destination MTC-Server identification in operation. For each received packet, the S-GW may examine the IP header or the addressable WTRU-Id the find out the target UE for which the packet is intended.

In various embodiments, there may also be sharable paths between eNodeBs in order to support mobility. In such embodiments, and similar to the eNodeB and MME sharable path establishment case described above, such paths may be established when the eNodeBs power up, when the eNodeB reset using procedures (e.g., an X2 Setup procedure, an X2 Reset procedure, and/or an X2 ENodeB Configuration Update procedure), or at other suitable times.

For the dynamic sharing connectivity, the activation and deactivation procedure (and logic) may be located in the corresponding MME or, for example, it may be located in any other CN node or the RAN. At the triggering time, the MME may issue the sharing path activation or deactivation command toward the eNodeB for the path between the eNodeB and MME path or toward the eNodeB and/or S-GW for the path between the eNodeB and S-GW path. In some embodiments, the MME may be notified by the MTC device, eNodeB or S-GW to issue the sharing path activation and/or deactivation commands.

The MTC device or MTC device aggregation node may indicate whether a dynamic sharing connectivity path or a static or semi-statically configurable sharable path may be used for its data communications. In some embodiments, the information may be queried, or otherwise obtained, with the MTC IMSI stored in the HLR/HSS.

In some embodiments, the shared MTC connectivity described herein may used with relay nodes. In some embodiments incorporating a relay node, bearers (with predefined QoS attributes, for example) may be established over the backhaul link, for example, on the Un interface between the relay and the Donor eNodeB for the MTC traffic sharing. The multiplexing of MTC devices radio bearers over the relay backhaul may follow rules similar to those described above. Moreover, in embodiments where the device visible to the network is an MTC aggregation node, a special MTC aggregation node identity similar to a Cell Radio Network Temporary Identifier (CRNTI), for example, a specific MTC aggregation node LCID, or a combination of the two may be used to provide multiplexing or demultiplexing at the MAC level at the MTC device aggregation node (UE) side and/or the network side. Furthermore, all MTC traffic may be routed through the sharing bearer UL and DL, so frequent establishment or modification to the Un interface bearers may be avoided. In some embodiments, MTC traffic may be buffered at the relay, e.g., for UL or the Donor NodeB, e.g., for DL to help smooth out the peak traffic load which may exceed the allocated throughput capability of the sharing path.

In some embodiments, the shared MTC connectivity described herein may used with a Home eNodeB. The MTC data sharing connectivity starting from a Home eNodeB may be generally similar to that of the eNodeB embodiments described above. With the use of local GW, the MTC sharable path may be configured to be SIPTO like traffic. In some embodiments, the LGW may be connected directly to an MTC server or an MTC GW.

The Home eNodeB may take the personality of a MTC device aggregation point with, for example, a special MTC device identification. The traffic from the MTC devices under the control of the Home eNodeB may be multiplexed at the Home eNodeB. This multiplexing may be transparent to the RAN and the core network, while being non-transparent to the MTC server. The Home eNodeB as a MTC device aggregation point may also appear to the network as a regular UE with the associated special user plane bearers reserved for MTC devices signaling and data traffic. Moreover, the path taken by the MTC device in a Home eNodeB subsystem may depend on the CSG profile of the device. For example, the closed subscriber group (CSG) members may take a different path than the non-members in a hybrid CSG cell.

In some embodiments, CSG cells may be accessed by MTC devices only. As used herein, MTC devices may include devices that are configured to operate as low priority devices, delay-tolerant, or any other type of device. Accordingly, MTC devices are not limited to UEs that are termed “MTC devices.” In embodiments with the CSG cell only used by MTC devices, a CSG cell may broadcast a specific indication to inform the UEs that only an MTC device may access the cell. This indication may be put in any broadcast message.

In some embodiments, the UEs may receive the information via dedicated RRC, NAS, OMA DM, OTA, etc., messaging where the UE is informed about what cell it can access as an MTC device. In these embodiments, UEs may have an indication per CSG identities (e.g., in a CSG whitelist, in an operator CSG list, in an allowed CSG list, in the USIM, or any combination thereof) that indicates if the CSG should only be accessed by MTC devices. The normal access check may still be applicable.

In some embodiments, a CSG cell may not be accessed by non-MTC devices. Further, these UEs may only access the cell to make an emergency call or during specific times, for example. Any specific time or event during which the non-MTC device is allowed to access a MTC-CSG cell may be either broadcast or provided to all UEs or to non-MTC UEs via dedicated messaging as described above.

In accordance with various embodiments, MTC devices may be informed or allowed to access the existing CSG cells only within a specific time period, upon the occurrence of a specific event (e.g., when there is an emergency session or when a traffic of a certain QoS is required), or during the existence of other conditions. This information may be provided to the MTC devices via broadcast or dedicated RRC/NAS messages, or other suitable messages, such as the messaging described above. The MTC devices may have an indication next to each CSG ID (e.g., in the whitelist, operator CSG list, or allowed CSG list) for which this restricted access applies.

The network may also reserve a specific set of CSG IDs that can be used by MTC devices only, or that allow MTC devices to use access them during certain time intervals or when certain events occur. The network may provide the MTC devices with these CSG IDs via dedicated messaging (RRC, NAS, etc.), or the MTC devices may be configured with this information (e.g., in the USIM).

Generally, the systems and methods described herein may also be used to avoid RAN-based congestion control where many MTC devices might try accessing the network and cause congestion such that non-MTC devices cannot access the system.

A network supporting MTC connectivity sharing may need to make it public for the capable MTC devices to utilize the provisions. In some embodiments, one or more of the following systems and methods may be used for publishing or otherwise providing a notification regarding supportability and MTC connectivity sharing configurations.

In some embodiments, a RAN SIB broadcast may be utilized. For example, the eNodeB or cell may announce its support or the network support and configurations to the MTC special operations including the MTC connectivity sharing by System Information Broadcasting. The information may be included in an existing SIB or in a separate or new SIB, so the MTC support can be recognized by the presence of this new SIB, for MTC operation.

In some embodiments, the MTC connectivity sharing configuration or context may contain one or more of the following information elements:

(1) The MTC connectivity sharing indicator for the RAN or the CN or for the whole PLMN; and/or

(2) One or more MTC Connectivity sharing-traffic-indicator(s) or Identifier(s).

Each information element may represent the sharing-traffic-indicator for one or more distinct MTC device or traffic categories (e.g., to a specific MTC-user/subscriber, to a specific MTC-service, or to a specific network end point such as a MTC-server, a P-GW, or an APN).

The Uu traffic path may need to support the segment-based MTC connectivity sharing because the MTC sharable data traffic may not use the conventional U-plane bearer/context setting. The system information may need to broadcast the special configurations for supporting the MTC connectivity sharing setting. In some embodiments, a special MTC bearer ID or IDs may be needed for the MTC traffic or for the MTC sharable data traffic from the MTC devices to indicate the possible need of special treatment in an eNodeB (determine the routing and sharing) for the MTC header parameters. The MTC bearer ID or IDs may bear the significance and ID value range in the MAC LCID domain. Special uplink resources and scheduling may be allocated and published to accommodate the MTC sharable data traffic.

In some embodiments, the MTC Connectivity Sharing broadcast information may be encrypted in system information and the key may be sent by the network to the individual MTC devices wanting to use the shared path by a dedicated message or messages.

In some embodiments, a dedicated message or messages may be utilized to publish or otherwise provide a notification regarding the supportability and MTC connectivity sharing configurations. The sharing-traffic-indicator value may be assigned via dedicated signaling messages, such as NAS, RRC, OMA DM, OTA, and/or L1/L2 messages, etc. from the network to a particular MTC device and/or to a particular MTC sharable traffic. The connectivity sharing parameters may also be brought to a MTC device via one or more of the following:

(1) At the MTC downlink device triggering or reaching time (e.g., through a paging message or through a MTC-RNTI signaling for MTC device triggering or reaching);

(2) An Attach Accept or a TAU Accept message or other NAS level downlink messages such as an “Activate Default EPS Bearer Context Request” message or an “Activate Dedicated EPS Bearer Context Request” message or a “Modify EPS Bearer Context Request” message or a NAS “Notification” message or a new NAS message;

(3) A positive response from the network on a UE/MTC device “Service Request” or an “Extended Service Request” (e.g., through the LTE “RRC Connection Reconfiguration Request” or the UMTS “Radio Bearer Reconfiguration Request”); and/or

(4) A downlink message in the RRC connection establishment time, e.g., a LTE RRC Connection Setup Request message or a UMTS RRC Connection Setup Request or Radio Bearer Setup Request, etc.

In some embodiments, USIM parameters may be utilized to provide a notification regarding the supportability and MTC connectivity sharing configurations. For example, the network and/or the MTC operators may configure the MTC device or the UE carrying MTC tasks with one or more of the following USIM or UICC device parameters:

(1) The MTC-Device ID;

(2) The MTC device class, which may be related to UE capability;

(3) The MTC device category (e.g., MTC only, UE with MTC, stationary, low mobility, normal mobility);

(4) The MTC services it is subscribed to perform (e.g., metering, security monitoring, event monitoring, earthquake monitoring, flood monitoring, level monitoring, etc.); and/or

(5) MTC Device wake up scheduling.

The MTC device wake up scheduling may include one or more extended long MTC Discontinuous Reception (DRX) cycles, defined rules on mixing different length DRX cycles, and/or a special wake up time. Further, for the MTC connectivity sharing, one or more sharing-traffic-indicator values may also be configured or reconfigured in the USIM to different data traffics corresponding to the device class/category/service that the MTC device is to generate.

In some embodiments, a notification or indication regarding the supportability and MTC connectivity sharing configurations may be downloaded from a core network entity. The MTC sharing context and other MTC sharing parameters (e.g., MTC sharing indicator, traffic indicator, bearer IDs, and/or other parameters) may be downloaded from a CN entity, such as the ANDSF or DNS server, for example. The MTC device may query these CN entities and may receive these configurations and parameters as a response. To support this scenario, an enhanced ANDSF function or DNS function may be utilized.

In accordance with various embodiments, header parameters may be formatted on top of the MTC data to be transmitted so the network can correctly route the data traffic and share a connectivity path to the designated MTC-server. One or more of the following parameters may be included in the header:

(1) The destination MTC-server Identification or FQDN or IP-address;

(2) The MTC Device Identity, which may be either permanent or temporarily assigned;

(3) The type of the MTC data, e.g., indicating the service or priority of the traffic, which may be associated with the MTC device class/service category;

(4) The sharing-traffic-indicator value of the MTC traffic; and/or

(5) The retransmission or acknowledgement need indicator.

The MTC traffic parameters may be placed next to the MTC sharable data on top of (or be placed in) the UE PDCP Protocol Data Units (PDUs) to implement segment-based routing at the MTC data block level. The eNodeB may decode the MTC parameters at the MTC data block level above the PDCP to inspect the MTC traffic's destination ID/address to determine the routing and to inspect the sharing-traffic-indicator to determine the sharing. Subsequent network nodes, such as the S-GW, may also perform similar actions on routing and sharing for the MTC sharable data traffic block.

The MTC traffic parameters may be placed next to the MTC sharable data on top of (or be placed in) the NAS Generic message container (e.g., the C-plane NAS “UPLINK GENERIC NAS TRANSPORT” message is used for the MTC data traffic). In some embodiments, the MME may decode the MTC parameters to inspect the MTC traffic's destination ID/address to determine the routing and to inspect the sharing-traffic-indicator to determine the sharing. Subsequent nodes may also perform similar actions to route and share the MTC sharable data traffic block.

The MTC traffic parameters may be placed next to the MTC sharable data on top of (or be placed in) the RRC signal messages such as the C-plane RRC “ULInformationTransfer” message. The eNodeB may decode the MTC parameters at the MTC data block level (above the RRC) to inspect the MTC traffic's destination ID/address to determine the routing and to inspect the sharing-traffic-indicator to determine the sharing. Subsequent network nodes, such as the S-GW, for example, may also need to perform similar actions to route and share the MTC sharable data traffic block.

In various embodiments, the MTC device may be responsible for formatting the MTC parameters into the data PDU's uplink and the MTC-Server may be responsible for formatting the MTC parameters into the data PDU's downlink.

To assist the general MTC data traffic transmission and/or the MTC sharable data traffic transmission for connectivity sharing in the network, the MTC sharable data block may be transmitted with one or more of the following systems and apparatus described in more detail below.

In some embodiments, a MTC specific Logical Channel ID (LCID) may be used. For example, one or more special bearer IDs or indicators for identifying the MTC sharable data traffic from the device to indicate the need of special treatment in eNodeB (e.g., to determine the routing and sharing) for the MTC header parameters. The MTC traffic or MTC sharable data traffic may bear the MTC bearer ID or the MTC sharable data bearer ID as the LCID with one or more special values either predetermined for MTC or received from system information broadcast or from a dedicated message or messages. The LCID value for MTC may be, for example, encoded into the MAC-header “R/R/E/LCID/F/L” to identify the data block for MTC traffic or MTC sharable data traffic in the MAC Transport Block from the device.

For MTC traffic or for MTC sharable data traffic transmission from the UE/MTC device to the MTC-server via the PLMN (e.g., the AN and CN), there may be no specific PDP-context or EPS bearer needed. The access network (e.g., the RAN) node may deliver the MTC data or sharable data to the destination according to the MTC parameters in the transmitted MTC data from the UE/MTC device.

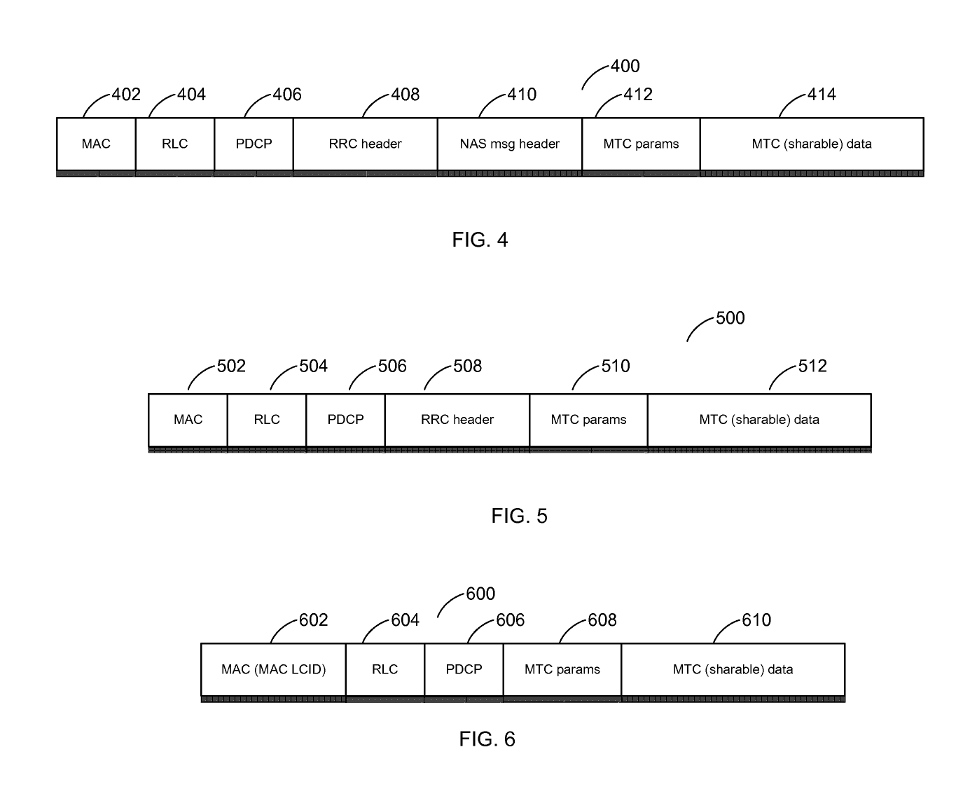

At connected mode, the MTC data traffic and/or the MTC sharable data traffic may go through the control plane to a MME via a new L3 message or via an existing NAS uplink message such as a UPLINK GENERIC NAS TRANSPORT message with a special indicator in the message to identify the MTC traffic or the MTC sharable data block traffic to the MME. At idle mode, the network may allow the UE/MTC device to use the NAS message carried over the RRC Connection Setup Complete message. The message may, for example, indicate explicitly via a new parameter that no normal EPS-bearer/PDP-context needs to be established, used or maintained subsequently for carrying the MTC data or the MTC sharable data. The message may, for example, carry the MTC data or MTC sharable data directly or a subsequent L3 data carries the MTC data or sharable data. The message structure may be similar to a message 400 illustrated in FIG. 4. As shown in FIG. 4, the message 400 may include a MAC portion 402, a RLC portion 404, a PDCP portion 406, a RRC header 408, a NAS message header 410, MTC parameters 412, and a MTC sharable data portion 414.

If the MTC traffic or the MTC sharable traffic does not use L3/NAS signaling messages, it may be transmitted in a variety of suitable formats. For example, it may be transmitted together with an RRC signaling message (e.g., a new one or an existing one with an MTC indicator) as payload over one of the SRBs and over the RRC connection as described above. In some embodiments, the message structure may be similar to the message 500 illustrated in FIG. 5. As shown in FIG. 5, the message 500 may include a MAC portion 502, a RLC portion 504, a PDCP portion 506, a RRC header 508, MTC parameters 510, and a MTC sharable data portion 512.

In some embodiments, the message may be a pure U-plane packet through a MTC specific U-plane bearer. The U-plane bearer may be between the UE/MTC device and the RAN and established through an RRC connection establishment procedure in which the UE/MTC device may request such a MTC specific U-plane setting in the RRCConnectionRequest message and the RAN may configure such an U-plane bearer with a MTC LCID or equivalent in the RRCConnectionSetupRequest message, as illustrated by message 600 in FIG. 6. As shown in FIG. 6, the message 600 may include a MAC portion 602 including a MAC LCID, a RLC portion 604, a PDCP portion 606, MTC parameters 608, and a MTC sharable data portion 610.

In some embodiments, instead of an MTC LCID, an MTC special identity in a range similar to a C-RNTI range may be used. For example, assuming multiple sharable paths are established where each path is mapped to a given QoS requirement, MTC traffics with the same QoS requirement from different MTC devices may be mapped to the same sharable path at the same QoS level. In such a case, a MTC special identity may be used in the MAC Protocol Data Unit (PDU) as a way to multiplex/demultiplex traffics that belong to different MTC devices for a MTC aggregation node.

In some embodiments, the U-plane data for a sharable specific context for a set of MTC devices may be mapped to a multicast broad group using a pre-configured or dedicated configured MBMS session. The session creation may be triggered by the MBMS counting procedure when the number of MTC devices exceeds a predefined threshold. In some embodiments, the session creation may be triggered for MTC devices configured and capable of MBMS operation, which may be indicated in the MTC device capability information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for managing machine type communications in a 3GPP network comprising a plurality of 3GPP network nodes, the method comprising:
routing a first communication from a first machine type communication (MTC) device toward a first MTC server through a logical 3GPP path between a first 3GPP network node and a second 3GPP network node, wherein the logical 3GPP path is assigned a path identifier; and
routing a second communication from a second MTC device toward a second MTC server through the logical 3GPP path.

2. The method of claim 1, wherein the logical 3GPP path is shared by the first communication and the second communication.

3. The method of claim 1, wherein the first communication and the second communication are contemporaneous.

4. The method of claim 1, wherein routing the first communication comprises routing the first communication through a sharable network segment comprising a plurality of sharable logical 3GPP paths between 3GPP network nodes.

5. The method of claim 4, further comprising:
assigning each of the plurality of sharable logical 3GPP paths a respective path indicator;
assigning the first communication a traffic indicator;
mapping the first communication to one of the plurality of sharable logical 3GPP paths based at least in part on the traffic indicator and the path identifier of the sharable path.

6. The method of claim 5, further comprising remapping the first communication based on a volume of network traffic.

7. The method of claim 4, further comprising multiplexing in the first and second communications in the sharable network segment.

8. The method of claim 7, further comprising:
storing a first address for the first MTC device; and
storing a second address for the second MTC device.

9. The method of claim 8, wherein the first address is any of a first IP address, a first WTRU address, or a first destination MTC-Server identification.

10. The method of claim 9, wherein the second address is any of a second IP address, a second WTRU address, or a second destination MTC-Server identification.

11. The method of claim 7, wherein multiplexing comprises at least one of using deep packet inspection and using a lookup table.

12. The method of claim 1, wherein the first 3GPP network node is a first network node in one of a Radio Access Network (RAN) and a Core Network (CN) and the second 3GPP network node is a second network node in one of the RAN and the CN, wherein the first network node and the second network node are in communication via a physical connection.

13. The method of claim 12, wherein the first 3GPP network node is an eNode B and the second 3GPP network node is an eNode B.

14. The method of claim 12, wherein the physical connection comprises an X2 interface.

15. The method of claim 1, wherein the first 3GPP network node is an eNode B and the second 3GPP network node is a Mobility Management Entity (MME).

16. The method of claim 15, wherein the first 3GPP network node and the second 3GPP network node are in communication via a physical connection.

17. The method of claim 16, wherein the physical connection comprises a S1-MME interface.

18. The method of claim 17, wherein the first communication is routed from the first MTC device toward the first MTC server through the S1-MME interface.

19. The method of claim 1, wherein the first 3GPP network node is a Node B and the second 3GPP network node is a Radio Network Controller (RNC).

20. The method of claim 1, wherein the first 3GPP network node is a Radio Network Controller (RNC) and the second 3GPP network node is a Serving GPRS Support Node (SGSN).

21. The method of claim 1, wherein the first 3GPP network node is an eNode B and the second 3GPP network node is a Serving Gateway (S-GW).

22. The method of claim 21, wherein the eNode B and the Serving Gateway (S-GW) are in communication via a physical connection comprising a S1-U interface.

23. The method of claim 22, wherein the first communication is routed from the first MTC device toward the first MTC server through the S1-U interface.

24. The method of claim 1, wherein the first 3GPP network node is a Mobility Management Entity (MME) and the second 3GPP network node is an MTC Gateway (MTC-GW) node for interworking to a MTC-Server.

25. The method of claim 1, wherein the first 3GPP network node is a Serving Gateway (S-GW) and the second 3GPP network node is an MTC Gateway (MTC-GW) node for interworking to a MTC-Server.

26. The method of claim 1, wherein the first 3GPP network node is a relay node and the second 3GPP network node is a donor eNodeB.

27. The method of claim 1, further comprising informing the first and second MTC devices of a sharable network segment capability.

28. The method of claim 27, wherein the informing comprises broadcasting a System Information Broadcast (SIB).

29. The method of claim 27, wherein the informing comprises:
transmitting a first message to the first MTC device; and
transmitting a second message to the second MTC device.

30. The method of claim 27, wherein the informing comprises using a Universal Subscriber Identity Module (USIM).

31. The method of claim 1, further comprising selectively activating or deactivating sharing of the logical 3GPP path based on at least one of a predetermined time, an event, and a command.

32. The method of claim 1, further comprising handling a message that indicates that subsequent sharable traffic is to use connectivity sharing, wherein routing the second communication comprises routing in accordance with the message, wherein the message includes any of a layer-three message or a NAS uplink message.

33. A device for managing machine type communications in a 3GPP network comprising a plurality of 3GPP network nodes, the device comprising:
a processor configured for first routing and for second routing,
wherein the first routing includes routing a first communication from a first machine type communication (MTC) device toward a first MTC server through a logical 3GPP path between a first 3GPP network node and a second 3GPP network node, wherein the logical 3GPP path is assigned a path identifier, and
wherein the second routing includes routing a second communication from a second MTC device toward a second MTC server through the logical 3GPP path.

34. The device of claim 33, wherein the logical 3GPP path is shared by the first communication and the second communication.

35. The device of claim 33, wherein the first communication and the second communication are contemporaneous.

36. The device of claim 33, wherein first routing comprises routing the first communication through a sharable network segment comprising a plurality of sharable logical 3GPP paths between 3GPP network nodes.
